(19) United States
(12) Patent Application Publication
(10) Pub. No.: US 2019/0102711 A1
(43) Pub. Date: Apr. 4, 2019

(54) APPROACH FOR GENERATING BUILDING SYSTEMS IMPROVEMENT PLANS

(71) Applicant: Siemens Industry, Inc., Alpharetta, GA (US)

(72) Inventor: Larry Wesley Walker, Algonquin, IL (US)

(73) Assignee: Siemens Industry, Inc., Alpharetta, GA (US)

(21) Appl. No.: 15/720,019

(22) Filed: Sep. 29, 2017

(51) Int. Cl. G06Q 10/06; G06Q 10/10; B60H 1/00

(52) U.S. Cl. CPC G06Q 10/0631; B60H 1/00964; G06Q 10/10; G06Q 10/0635

(57) ABSTRACT

Capabilities of the building automation system are assessed with assessments that are used to generate plans and justification for upgrading or servicing the building automation system.

### TECHNICAL FIELD

The present invention relates generally to building automation system and more particularly to assessing capabilities of the building automation system.

### BACKGROUND

Most modern buildings are built with security systems, emergency systems, heating, ventilating, and air conditioning (HVAC) systems, all of which have many sensors, fans, values, and actuators. These systems together are commonly referred to as a building automation system (BAS). The amount of automation for the building may be in the spectrum of no automation to fully automate. Many of these automation devices are controlled by microcontroller or microprocessor located in field panels dispersed throughout a building or even a campus. The elements that make up the BAS are typically called points, panels, and equipment. Due to the rapid advancement of technology, different level of automation devices may exist within BAS. When upgrading the BAS, decisions have to be made on what areas or devices are replaced or upgraded. With all such opportunities for modernization, resources are limited and highest return projects or projects creating the greatest stability should be undertaken. Currently, such decisions are made in an adhoc manner with little understanding of the BAS capabilities and potential configuration.

In view of the foregoing, there is an ongoing need for systems, apparatuses and methods for generating building systems improvement plans.

### SUMMARY

An approach is provided for gathering BAS information, evaluating the capabilities of the BAS, and generating potential actions for improvement of the BAS. The term BAS is used to include a building's automation systems, infrastructure, and actual structure. Assessments are conducted of the BAS, results are analyzed, and weighted recommendations are generated. In addition to recommendations, justification and other data for supporting the recommendations are provided. The assessments result in assessment data being stored in a data store where that data is processed with a processor and resulting data stored in the data store. The results are then further processed by the processor to generate the resulting weighted recommendations.

Other devices, apparatus, systems, methods, features, and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1 is an illustration of a building automation system (BAS) in accordance with an example implementation.

FIG. 2 is an illustration of a processor controlled device executing the approach for evaluation of the viability of a BAS of FIG. 2 in accordance with an example implementation.

FIG. 3 is an illustration of an approach for the evaluation of the viability of the BAS of FIG. 1 in accordance with an example implementation.

FIG. 4 is a diagram of the infrastructure condition assessment of FIG. 3 in accordance with and example implementation.

FIG. 5 is a diagram of the risk profile assessment of FIG. 3 in accordance with an example implementation.

FIG. 6 is a diagram of the service priorities of FIG. 3 in accordance with an example implementation of the invention.

FIG. 7 is a diagram of the useful service life assessment of FIG. 3 in accordance with an example implementation of the invention.

FIG. 8 is a diagram of the energy and operational savings of FIG. 3 in accordance with an example implementation.

FIG. 9 is a diagram of results generated from the processed assessments of FIG. 3 in accordance with and example implementation.

FIG. 10 is a diagram of weighted recommendations of FIG. 3 in accordance with an example implementation.

FIG. 11 is a flow diagram of the approach for the evaluation of the viability of the BAS of FIG. 1 in accordance with an example implementation.

### DETAILED DESCRIPTION

As used herein, an approach is described for the evaluation of the viability of a building automation system (BAS) that results in weighted recommendations. The term BAS is used to include a building's automation systems, infrastructure, and actual structure.

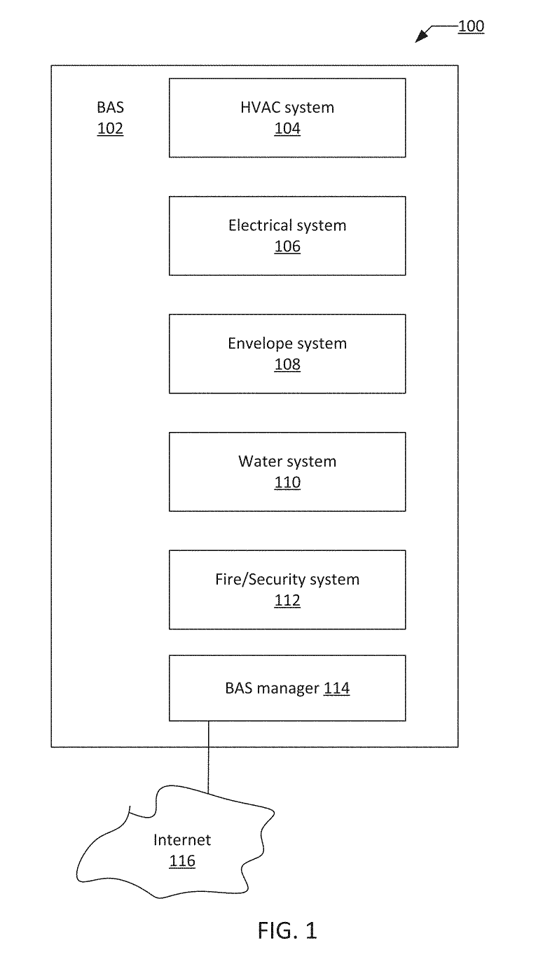

Turning to FIG. 1, an illustration 100 of a building automation system (BAS) 102 in accordance with an example implementation. The BAS 102 typically has a number of subsystem, such as heating, ventilation and air condition (HVAC) system 104, electrical system 106, envelope system 108, water system 110, fire/security system 112, and a manager or controller 114. In practice a number of points, controllers, panels, motors, sensors, and additional equipment may compose one or more of the systems. Further, other BAS may have additional or few systems and may be dependent upon the size of the building or campus being controlled. Current BAS with managers or controllers, such as 114 are connected to local networks and wide area networks (i.e. the cloud or internet 116).

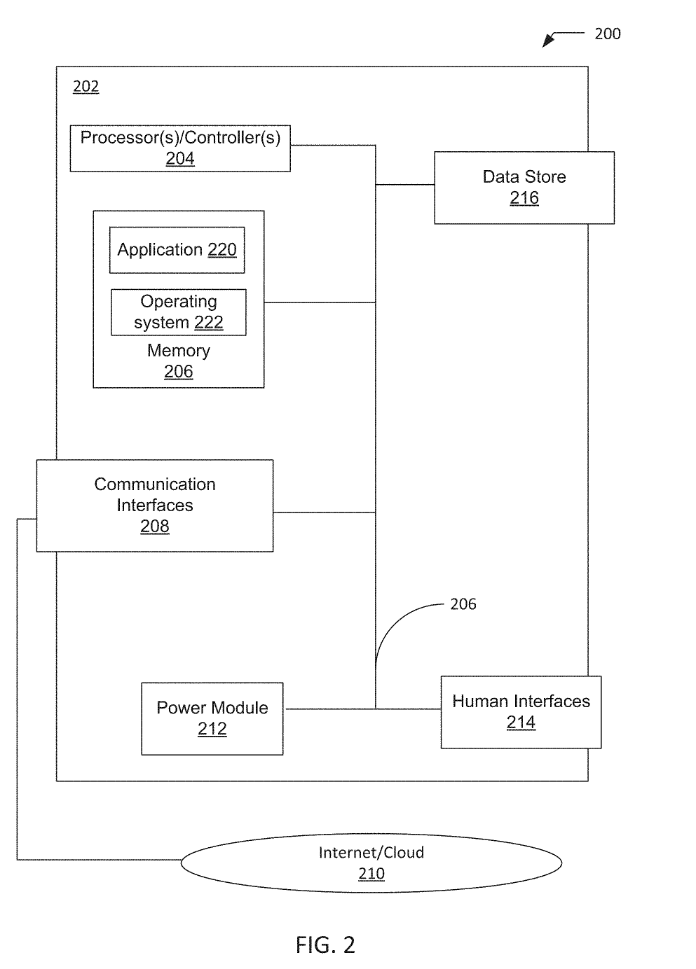

In FIG. 2, an illustration 200 of a processor controlled device 202 executing the approach for evaluation of the viability of a BAS 102 of FIG. 1 in accordance with an example implementation. A processor or controller 204 is coupled to a memory 206, communication interfaces 208, power module 212, human interfaces 214, and data store 216 by bus 206. The bus 206 may be divided into a data bus and address bus. The memory 206 is divided into an application memory 220 and operating system memory 222. The communication interfaces 208 connect to other networks, such as the internet/cloud 210. The human interfaces 214 enable the processor controlled device 202 to monitors, keyboards, and mice. The data store 216 is typically an internal hard disk, but my be any type of permanent or semi-permanent memory device such as CDs, DVDs, hard disk drives, tape drives, solid state drives, or a combination of the previous. The instructions for the approach for evaluation of the viability of the BAS 102 is stored in application memory 220 and executed by the processor controller 204.

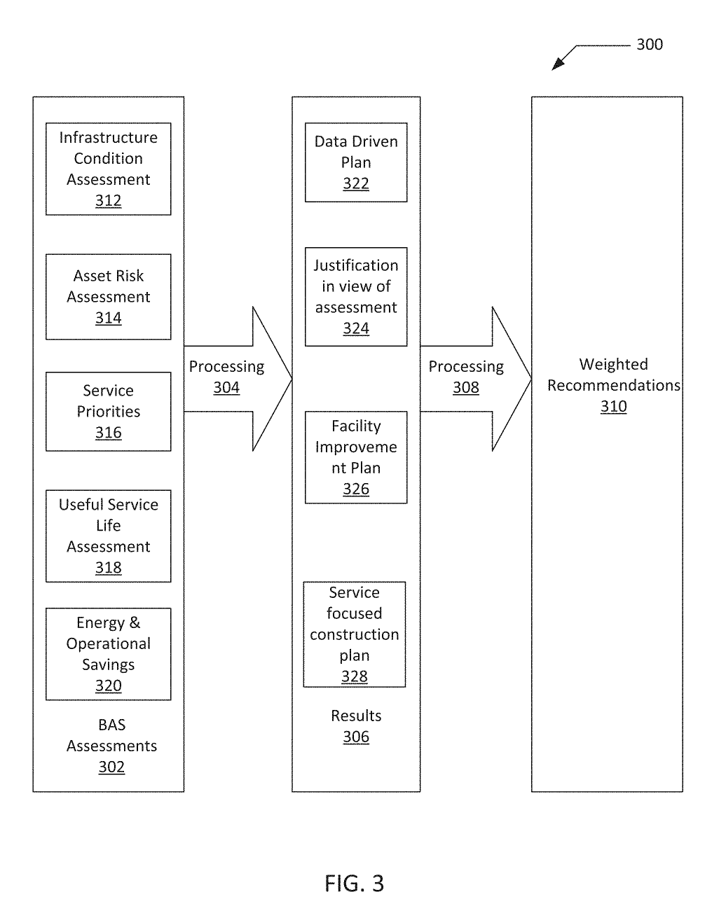

Turning to FIG. 3, an illustration 300 of an approach for the evaluation of the viability of the BAS 102 of FIG. 1 in accordance with an example implementation. The approach starts by collection of data during a BAS assessment period 302. Data from the infrastructure condition assessment 312 is collected and entered into a data store 216 accessible by a processor or controller 204. An asset risk assessment 314 is conducted identifying the risk of parts of the BAS failing or degrading over time. The data gathered from the risk assessment is similarly stored in the data store 216. The service priorities 316 of the operators of the BAS 102 are identified and that data is stored in the data store 216.

The stored data is then processed 304 and results 306 presented. The stored BAS assessment 302 data is compared to stored historic data from similar BAS and combined with known data such as costs and time lines to generate results, such as a plan for replacement and upgrading the BAS 102 is derived and presented as a data driven plan 322. Using the collected data and the stored historic data a justification in view of the assessment 324 is generated. Using the assessment data 302 and data driven plan along with cost data and installation time data a facility improvement plan 326 is generated. Finally a service focused construction plan is generated 328. In other implementations, more or less data assessments may be employed and more or less results may be generated. The results 306 are then further processed by the processor 204 resulting in weighted recommendations 310. The resulting weighted recommendations 310 contain recommendations for repairing and upgrading the BAS in accordance with not only physical issues, such as aging infrastructure, but also in view of service priorities of the operators/owners/users of the BAS.

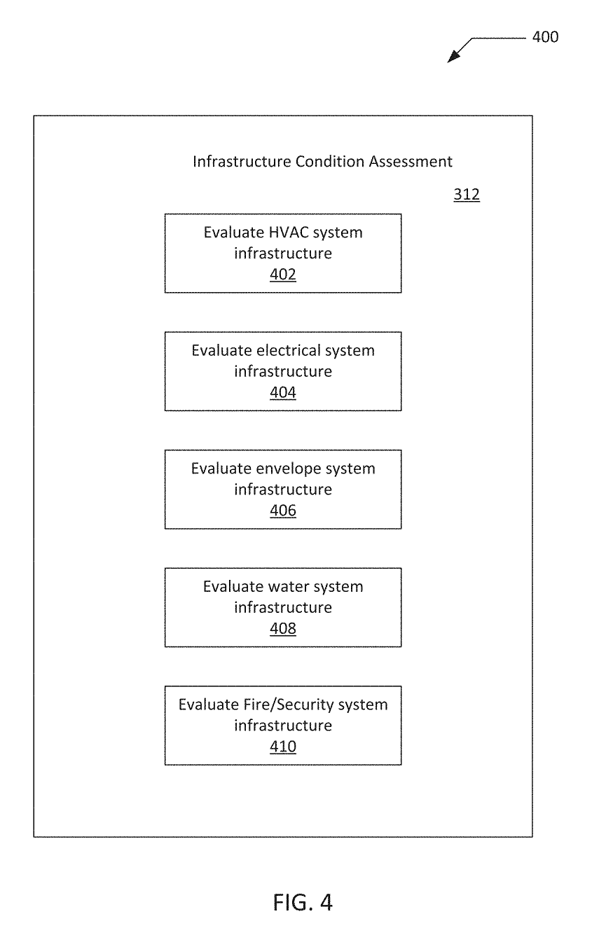

In FIG. 4, a diagram 400 of the infrastructure condition assessment 312 of FIG. 3 is depicted in accordance with and example implementation. The HVAC system infrastructure is evaluated 402 and scores given to the different parts. Each of the components or elements of the HVAC system are identified using identification data. This identification data is acquired via a database of elements stored in the BAS 102 or a discovery tool that polls the BAS 102 and BAS manager 124 to identify the elements. Older elements of the HVAC system infrastructure may have to be identified manually and added to the identification data. One the elements have been identified, the condition each element is assigned a value. In the current example, a range of one to five may be assigned by the processor to each element where five is fully functioning and one is non-functioning. The value may be derived by accessing historic, log, operationally, and predicted performance data for the different elements maintained in the BAS. The results of the evaluation are then stored in the data store 216.

The electrical system 108 infrastructure is evaluated 404 in a similar manner to the HVAC system. The evaluation is a combination of configuration information contained in the BAS database, collected data, and performance data. This data is then used by the processor 204 to assign a value (one to five as explained above) to the equipment and/or elements that make up electrical system 108. The evaluation results of the electrical system infrastructures are then stored in the data store 216.

The envelope system infrastructure is evaluated 406. The envelope system 108 is the outer structure of the building including, but not limited to roof, windows, and doors. The evaluation of the envelope system 108 will typically occur with the use of surveys and technicians gather the data is a machine readable format. The results of the survey of the envelope system are read indirectly by the processor 204 using a scanner or other peripheral device (not shown) connected to a communication interface 208. The envelope system evaluation data is stored in the data store 216 by the processor.

If a water system is part of the BAS 102, the water system 110 infrastructure is evaluated in a similar manner as the HVAC system 104. The results of the evaluation are stored in the data store 216 by the processor 204. Also, the fire/security system 112 is evaluated in a similar manner as the HVAC system 104. The processor stores the results in data store 216.

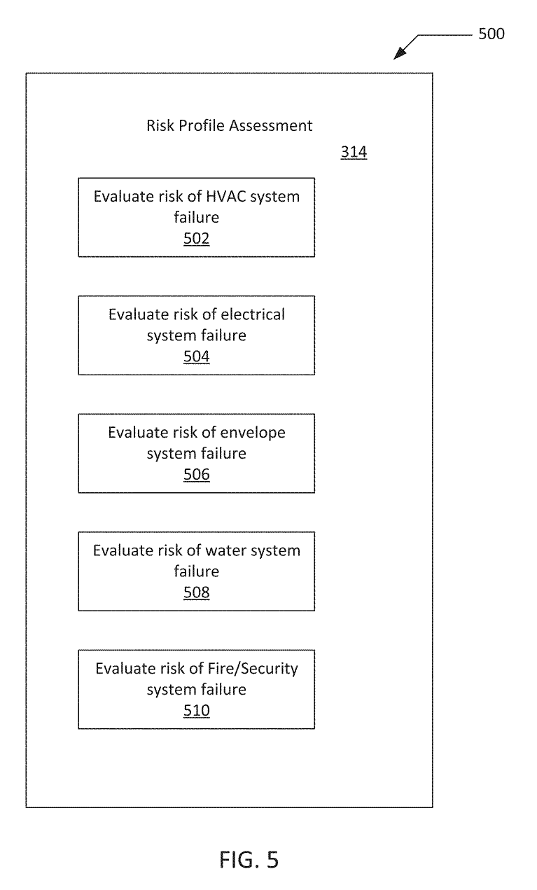

Turning to FIG. 5, a diagram 500 of the risk profile assessment 314 of FIG. 3 in accordance with an example implementation. The evaluated risk of failure of a system (HVAC system failure 502, electrical system failure 504, envelope system failure 506, water system failure 508, and fire/security system 510 failure). The determination of a risk of a failure of a system is determined by processing the historic operational data of the BAS 102. A numerical risk value is assign to the risk of failure. The risk value is determined in the current example by the combination of the likelihood of failure (%) multiplied by the impact of a failure (range of 1-5), to get a numerical risk value. The results are stored in the data store 216 by the processor 204.

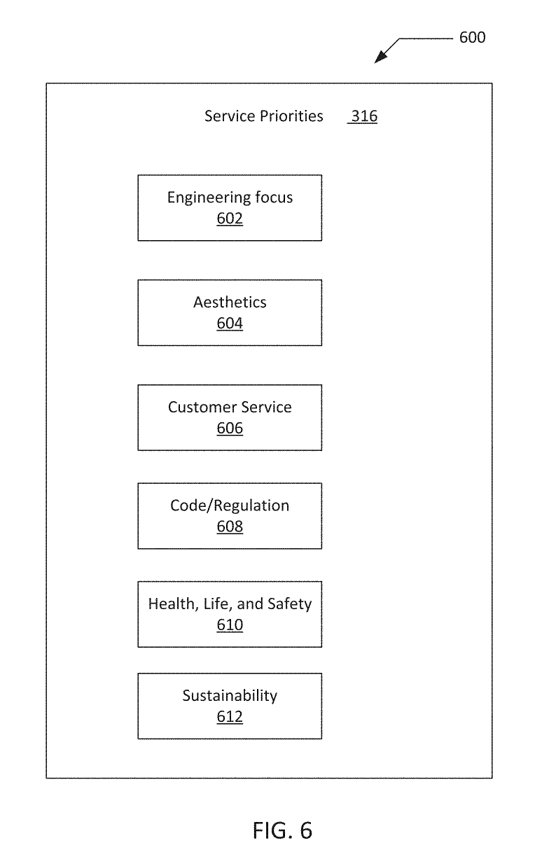

In FIG. 6, a diagram 500 of the service priorities 316 of FIG. 2 is depicted in accordance with an example implementation of the invention. BAS projects planned or desired by building engineers are identified and ranked using a 1-5 range. The engineering focus data is then stored in the data store 216 by processor 204. User visible projects or “aesthetic” projects 604 (projects that building users will be impacted by) are identified and ranked using a 1-5 range. These ranked aesthetic projects and their rankings are stored in the data store 216 by processor 204. Customer service 606 issues relating to the BAS 102 are identified and also stored in the data store 216 by processor 204. Code/regulations 608 affecting the BAS 102 are listed and an indication is made as to if it is complied with. Furthermore, the element or system of the BAS 102 affected by the code or regulation is identified. The resulting data is then stored in the data store 216 by processor 204. Similarly, health, life, and safety issues are identified along with the associated elements and systems in the BAS 102. The issues, elements, and system identified are stored in the data storage 216 by processor 204. The sustainability 612 or “greenness” of the elements and systems in the BAS 102 are scored on a scale from 1-5 (Green being 1 and 5 being wasteful). The resulting data associated with sustainability 612 is stored in data store 216 by processor 204.

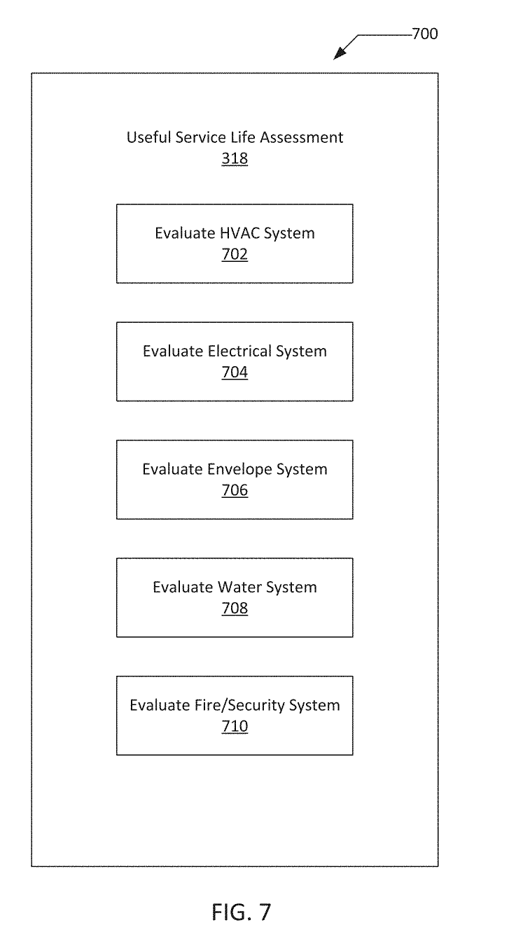

Turning to FIG. 7, a diagram 700 of the useful service life assessment 318 of FIG. 3 is depicted in accordance with an example implementation of the invention. The elements that make up the systems (HVAC 104, electrical 106, envelope 108, water 110, and fire/security 112) in the BAS 102 have expected or predicted operational life. The expected or predicted operational life often is identified by the element's manufacturer or industry standards e.g. American Society of Heating, Refrigerating and Air-Conditioning Engineers (ASHRAE) or United States Department of Housing and Urban Development (HUD). In some instances, operational data and mean times between failures may be collected from other BAS. The service life data associated with the elements of the systems are identified and a service life for a subsystem may also be evaluated from the service life data, such as evaluating the service life the HVAC system 702, electrical system 704, envelope system 706, water system 708, and fire/security system 710. The resulting evaluated service life assessment data is stored in data storage 216 by processor 204.

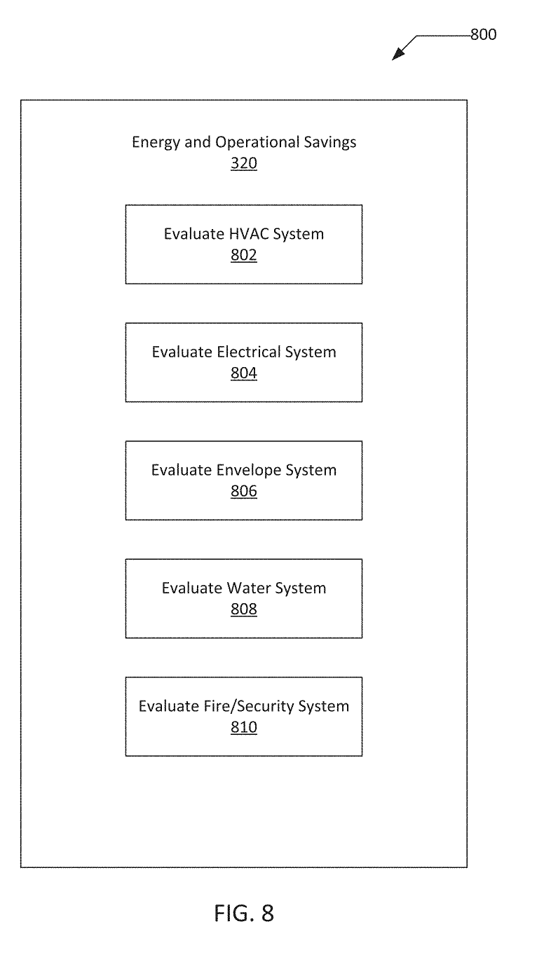

In FIG. 8, a diagram 800 of the energy and operational savings 320 of FIG. 3 is depicted in accordance with an example implementation. A data store of energy and operational savings associated with updated or current state of the art elements, panels, and devices that make up the different systems are typically known and stored in a database in the cloud or locally. The energy and operational savings is evaluated or derived using the known savings from the database for the systems that make up the BAS 102, such as evaluating the HVAC system 802, electrical system 804, envelope system 806, water system 808 and fire/security system 810. The assessed energy and operational savings 320 are then saved in the data store 216 by processor 204.

In other implementations, other ranges may be used when making assessments. It is desirable to have the same range being used when making assessments, but in other implementations different ranges may be normalized between assessments.

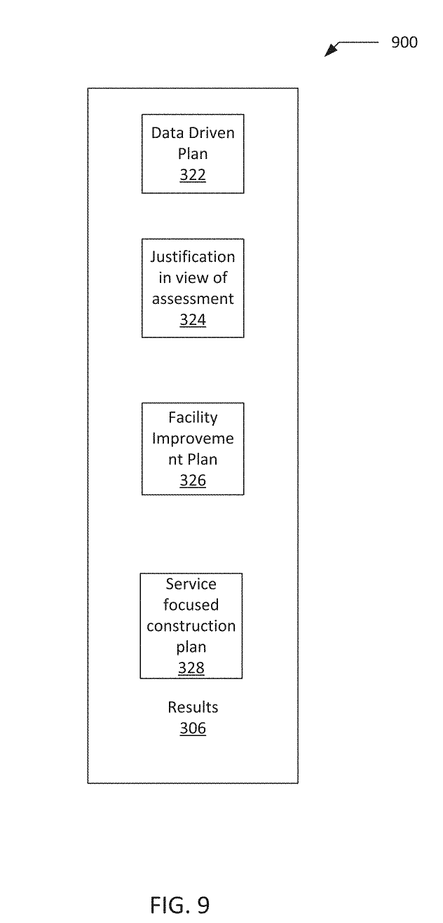

In FIG. 9, a diagram 900 of results 306 generated from the processed assessments 302 of FIG. 3 is depicted in accordance with and example implementation. The processor 204 reads the assessment data from the BAS assessments 302 that is stored in the data store 216 and processes the data 304 to generate results 306. The assessment data is used to create a data driven plan 322. The data drive plan 322 uses statistical analyses being applied to values assigned to the different systems and elements in the systems along taking into account the expected life of equipment, risks of failures, engineering focus, code/regulations, aesthetics, customer service, and sustainability to identify and derive a score for each potential project to improve the BAS 102. A minimum score is then used to reduce the number of potential projects by the processor 204 and present them in the data driven plan 322.

Using the potential projects presented in the data driven plan 322 and assessment data in the data store 216 the processor 204, justification in view of the assessments 324 are generated by the process. The justification provides the scoring value items associated with the potential projects. The scoring value items, such as likelihood of failure, life expectance of an element in the BAS. A facility improvement plan 326 is similarly derived by the processor 204 from the BAS assessment 302, data driven plan 322, justifications 324. The facility improvement plan 326 translates the data driven plan to the actual impact on the facility, such as outages of different parts of the BAS 102. A service focused construction plan 328 is generated using information stored in the data store 216 by the processor and project or historic data associated with improvements to the BAS 102. The service focused construction plan identifies the impact of the implementation of the upgrades or impartments of the BAS 102 on users of the buildings. Information such as the air condition would be out for a month, heating would be unavailable, or other parts of the BAS 102 would be down or degraded are contained in the service focused construction plan 328.

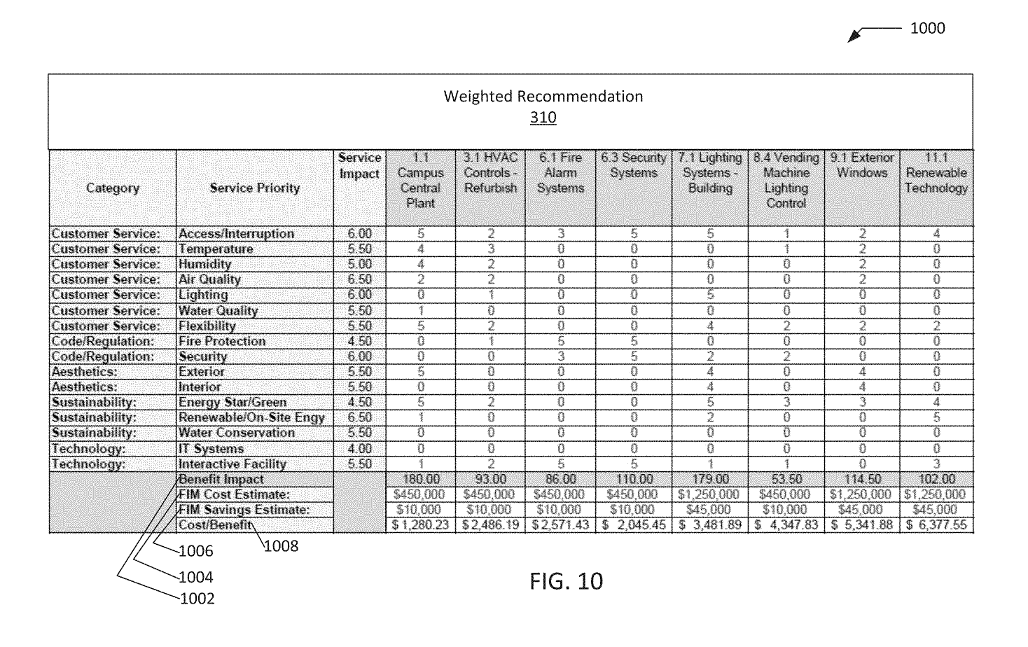

Turning to FIG. 10, a diagram 1000 of weighted recommendations 310 of FIG. 3 is depicted in accordance with an example implementation. Categories of assessments, such as “Customer Service”, “Code/Regulation”, “Aesthetics”, “Sustainability”, and “Technology” are listed. It is noted that FIG. 10 is a simplified version of a generated weighted recommendation report. The ratings for the different items assessments are also shown. The processed 304 FIG. 3 BAS assessment data 302 FIG. 3 and results 306 FIG. 3 are further processed 308 FIG. 3 by the processor to generate weighted recommendations 310. Benefit impact 1002 is calculated for each of the items by the processor the service impact times the assessment score is added together. A facility improvement measure (FIM) cost estimate is derived from the results 306 FIG. 3 data stored in the data store for the cost of the improvements or changes suggested for each of the items. The processor then accesses the data store and calculates a savings estimate 1006. A cost/benefit 1008 analysis is also generated by the processor using the cost estimate 1004 and benefit impact 1002.

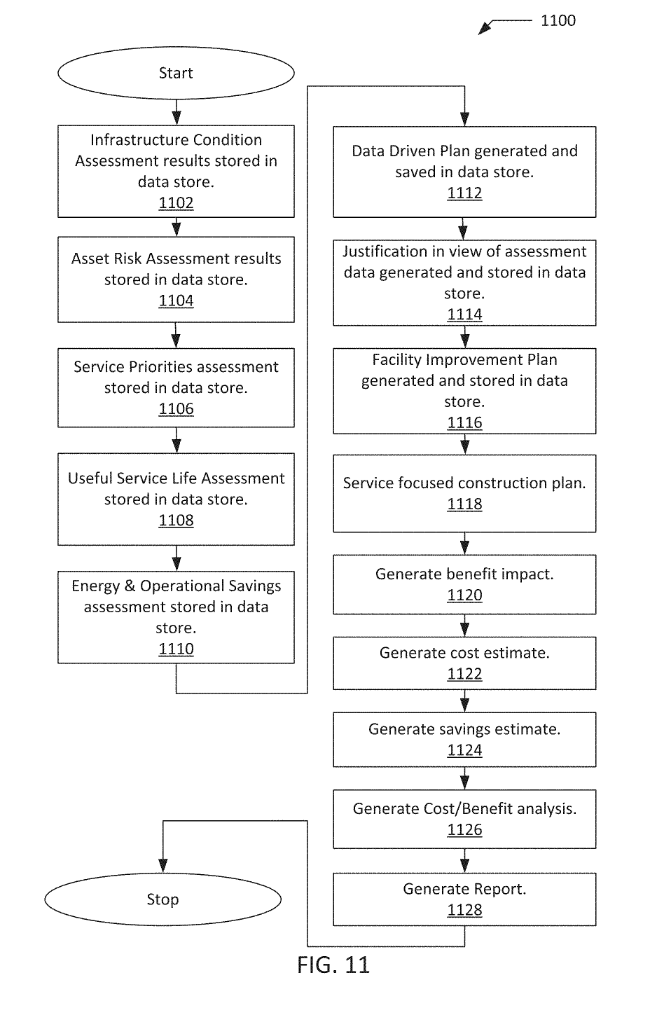

In FIG. 11, a flow diagram 1100 of the approach for the evaluation of the viability of the BAS 102 of FIG. 1 is presented in accordance with an example implementation. In step 1102, the infrastructure condition assessment results 312 are acquired and stored in the data store 216 by processor 204. In step 1104, the asset risk assessment result 314 is acquired and stored in data store 216 by processor 204. Turning to step 1106, the service priorities assessment are acquired and stored in data store 216. In step 1108, the useful service life assessment 318 is stored in data store 216 by processor 204. In step 1110, the energy & operational savings assessment 320 is stored in data store 216 by processor 204. Processing the BAS assessments 302 stored in the data store 216, the processor 206 generates the data driven plan in step 1112 and store din data store 216. The Justification in view of assessment 324 data generated in step 1114 and stored in data store 216. The facility improvement plan 326 is generated by the processor 206 in step 1116 and stored in data store 216. The service focused construction plan 328 is generated by processor 206 and stored in data store 216 in step 1118. The data in the data store 216 is then further processed and weighted recommendations 310 are provided. In step 1120 the benefit impact 1002 is generated by the processor 206. In step 1122, the cost estimate 1004 is generated by the processor. In step 1124 the cost savings estimate 1006 is generated and in step 1126 the cost/benefit analysis 1008 is generated. In step 1128, a report 1000 is generated and stored in data store 216.

It will be understood, and is appreciated by persons skilled in the art, that one or more processes, sub-processes, or process steps described in connection with FIG. 11 may be performed by hardware and/or software (machine readable instructions). If the approach is performed by software, the software may reside in software memory in a suitable electronic processing component or system such as one or more of the functional components or modules schematically depicted in the figures.

The software in software memory may include an ordered listing of executable instructions for implementing logical functions (that is, “logic” that may be implemented either in digital form such as digital circuitry or source code or in analog form such as analog circuitry or an analog source such an analog electrical, sound or video signal), and may selectively be embodied in any computer-readable medium for use by or in connection with an instruction execution system, apparatus, or device, such as a computer-based system, processor-containing system, or other system that may selectively fetch the instructions from the instruction execution system, apparatus, or device and execute the instructions. In the context of this disclosure, a “computer-readable medium” is any tangible means that may contain or store the program for use by or in connection with the instruction execution system, apparatus, or device. The tangible computer readable medium may selectively be, for example, but is not limited to, an electronic, magnetic, optical, electromagnetic, or semiconductor system, apparatus or device. More specific examples, but nonetheless a non-exhaustive list, of tangible computer-readable media would include the following: a portable computer diskette (magnetic), a RAM (electronic), a read-only memory “ROM” (electronic), an erasable programmable read-only memory (EPROM or Flash memory) (electronic) and a portable compact disc read-only memory “CDROM” (optical). Note that the tangible computer-readable medium may even be paper (punch cards or punch tape) or another suitable medium upon which the instructions may be electronically captured, then compiled, interpreted or otherwise processed in a suitable manner if necessary, and stored in a computer memory.

The foregoing detailed description of one or more embodiments of the approach for generating building systems improvement plans has been presented herein by way of example only and not limitation. It will be recognized that there are advantages to certain individual features and functions described herein that may be obtained without incorporating other features and functions described herein. Moreover, it will be recognized that various alternatives, modifications, variations, or improvements of the above-disclosed embodiments and other features and functions, or alternatives thereof, may be desirably combined into many other different embodiments, systems or applications. Presently unforeseen or unanticipated alternatives, modifications, variations, or improvements therein may be subsequently made by those skilled in the art which are also intended to be encompassed by the appended claims. Therefore, the spirit and scope of any appended claims should not be limited to the description of the embodiments contained herein.

What is claimed is:

1. A device that identifies and generates building automation system improvement plans, comprising:
infrastructure assessment data being identified by a processor and stored in a data store coupled to the processor;
asset risk assessment data being identified by the processor and stored in the data store;
service priorities data identified and stored by the processor in the data store;
a data driven plan and a justification assessment generated by the processor that processes at least the infrastructure assessment data, the asset risk assessment data, and the service priorities identified data; and
a weighted recommendation generated by the processor and stored in the data store using at least the data driven plan and the justification assessments.

2. The device that identifies and generates building automation system improvement plans of claim 1, where the weighted recommendation includes a cost/benefit calculation by the processor.

3. The device that identifies and generates building automation system improvement plans of claim 1, where the weighted recommendation includes a savings estimate generated by the processor.

4. The device that identifies and generates building automation system improvement plans of claim 1, where the infrastructure condition assessment includes at least an HVAC system infrastructure assessment and an electrical system infrastructure assessment.

5. The device that identifies and generates building automation system improvement plans of claim 1, where asset risk assessment data includes at least a risk of HVAC system failure assessment.

6. The device that identifies and generates building automation system improvement plans of claim 1, where generation of the weighted recommendation includes generation of a report of the weighted recommendations by the processor that is stored in the data store.

7. The device that identifies an generate building automation system improvement plans of claim 1, where the processor accesses additional data stored in the data store to generate the data driven plan.

8. A method for identifying and generating building automation system improvement plans, comprising:
identifying infrastructure assessment data by a processor and storing the infrastructure assessment data in a data store coupled to the processor;
identifying asset risk assessment data by the processor and storing the asset risk assessment data in the data store;
identifying service priorities data by the processor and storing the service priorities data by the processor in the data store;
generating a data driven plan and a justification assessment by the processor that processes at least the infrastructure assessment data, the asset risk assessment data, and the service priorities identified data; and
generating a weighted recommendation by the processor using at least the data driven plan and the justification assessments and storing the weighted recommendation in the data store.

9. The method for identifying and generating building automation system improvement plans of claim 8, where the weighted recommendation includes calculating a cost/benefit by the processor.

10. The method for identifying and generating building automation system improvement plans of claim 8, where the weighted recommendation includes generating a savings estimate by the processor.

11. The method for identifying and generating building automation system improvement plans of claim 8, where the infrastructure condition assessment includes at least an HVAC system infrastructure assessment and an electrical system infrastructure assessment.

12. The method for identifying and generating building automation system improvement plans of claim 8, where asset risk assessment data includes at least a risk of HVAC system failure assessment.

13. The method for identifying and generating building automation system improvement plans of claim 8, where generation of the weighted recommendation includes generating a report of the weighted recommendations by the processor and storing the report of weighted recommendations in the data store.

14. The method for identifying and generating building automation system improvement plans of claim 8, accessing additional data stored in the data store by the processor to generate the data driven plan.

15. A non-transitory machine readable plurality of instructions, that when executed performers a method for identifying and generating building automation system improvement plans, comprising:
identifying infrastructure assessment data by a processor and storing the infrastructure assessment data in a data store coupled to the processor;
identifying asset risk assessment data by the processor and storing the asset risk assessment data in the data store;
identifying service priorities data by the processor and storing the service priorities data by the processor in the data store;
generating a data driven plan and a justification assessment by the processor that processes at least the infrastructure assessment data, the asset risk assessment data, and the service priorities identified data; and
generating a weighted recommendation by the processor using at least the data driven plan and the justification assessments and storing the weighted recommendation in the data store.

16. The non-transitory machine readable plurality of instructions, that when executed performers the method for identifying and generating building automation system improvement plans of claim 15, where the weighted recommendation includes calculating a cost/benefit by the processor.

17. The non-transitory machine readable plurality of instructions, that when executed performers the method for identifying and generating building automation system improvement plans of claim 15, where the weighted recommendation includes generating a savings estimate by the processor.

18. The non-transitory machine readable plurality of instructions, that when executed performers the method for identifying and generating building automation system improvement plans of claim 15, where the infrastructure condition assessment includes at least an HVAC system infrastructure assessment and an electrical system infrastructure assessment.

19. The non-transitory machine readable plurality of instructions, that when executed performers the method for identifying and generating building automation system improvement plans of claim 15, where asset risk assessment data includes at least a risk of HVAC system failure assessment.

20. The non-transitory machine readable plurality of instructions, that when executed performers the method for identifying and generating building automation system improvement plans of claim 15, where generation of the weighted recommendation includes generating a report of the weighted recommendations by the processor and storing the report of weighted recommendations in the data store.

21. The non-transitory machine readable plurality of instructions, that when executed performers the method for identifying and generating building automation system improvement plans of claim 15, accessing additional data stored in the data store by the processor to generate the data driven plan.
